(19) United States
(12) Patent Application Publication
(10) Pub. No.: US 2013/0191640 A1
(43) Pub. Date: Jul. 25, 2013

(54) INFORMATION SYSTEM AND METHOD INCORPORATING A PORTABLE DIGITAL MEDIA DEVICE

(71) Applicant: Jeffrey Mitchell Bloomer, Tipp City, OH (US)

(72) Inventor: Jeffrey Mitchell Bloomer, Tipp City, OH (US)

(21) Appl. No.: 13/356,124

(22) Filed: Jan. 23, 2012

(51) Int. Cl. H04L 9/28

(52) U.S. Cl. 713/172

(57) ABSTRACT

A method of reading a readable element, such as a two dimensional bar code or an RFID chip, that has encrypted information with a portable device, such as a digital media device or RFID reader, includes storing a decryption key in the portable device, and scanning the readable element with the portable device. The method further includes communicating with a remote server storing a decryption key database, validating the decryption key stored in the portable device, and decrypting information from the readable element using the portable device. The decrypted information may then be displayed.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This relates to an information system and method incorporating a portable digital media device. This may be useful in a number of situations, such as for example in a medical setting involving patient medical information. A wide variety of portable digital media devices, sometimes referred to as smart phones, have been adopted and used in information systems to perform various functions, in addition to their operation as cell phones. Such devices include, for example, iPhone devices from Apple, Inc., Blackberry devices from RIM Inc., Android devices from Motorola, Inc., Nexus One devices from Google, Inc., or other similar devices. These devices have an associated display, an input arrangement such as a keyboard or a touch responsive display screen, and a memory in which are stored application programs that control the flow of information and processing of the information by the device and by remote servers. Portable digital media devices also include devices, such as an iTouch device, which have wireless communication capability, but which do not include a built-in cell phone. Devices like the iTouch device include a Wi-Fi, Mi-Fi, or other wireless broadband capability which permits communication between the devices, and remote equipment and computer systems. All of the portable digital media devices include a built-in video camera which is capable of capturing a barcode image.

In a number of settings it is important to control the dissemination of information. For example, it is important for physicians, nurses, pharmacists, hospital personnel, and other health care providers to have access to patient medical information that is needed to provide medical care for patients. Additionally, it is important for patients to have access to their own medical information. However, it is also important to guard patients' privacy and to release their medical information to various medical providers on a need-to-know basis. The Health Insurance Portability and Accountability Act of 1996 (HIPAA) Privacy Rule created national standards to protect individuals' medical records and other personal health information. It protects all individually identifiable health information that is held or transmitted by a covered entity or its business associate, in any form or media, whether electronic, paper or oral. It is considered important to minimize even the incidental disclosure of patient information to the extent possible.

Health care providers have adopted a number of changes in their standard procedures to limit the disclosure of patient health information beyond what is needed to provide medical services to patients in an effective and efficient manner. For example, most health care facilities take steps to make sure patient information is not retrievable by unauthorized individuals. It is, however, equally important for authorized healthcare providers to have quick, simple access to patient health information when it is needed, and to provide various providers and others, including the patient, only the information that may be needed and appropriate at the time. It will be appreciated that such control of the dissemination of information is important in a number of situations.

### SUMMARY

A method of reading a two dimensional barcode having encrypted information with a portable digital media device, includes the steps of storing a decryption key in the portable digital media device, and scanning the two dimensional barcode with the video camera of the portable digital media device. The method further includes communicating with a remote server storing a decryption key database using the portable digital media device to validate the decryption key stored in the portable digital media device, and decrypting information from the two dimensional barcode using the portable digital media device.

Some or all of the decrypted information may be displayed. The method may further contemplate using the portable digital media device to access a website specified by the decrypted information. The method further includes periodically changing the decryption key stored in the portable digital media device and in the remote database.

The decryption key may be valid for a specified geographic location. The portable digital media device may include a GPS receiver, and the portable digital media device may communicate the geographic location of the device as well as the decryption key to the remote database for validating the decryption key stored in the portable digital media device and validating the location of the portable digital media device. The decryption key may specify a portion of the encrypted information from the two dimensional barcode that is to be decrypted.

The portable digital media device and the remote server may communicate periodically to synchronize the decryption key. The portable digital media device and the remote server may communicate wirelessly. The portable digital media device and the remote server may communicate over a Wi-Fi connection. The portable digital media device and the remote server may communicate over the internet.

The decrypted information may include an internet address. The portable digital media device is then directed to access a website at the internet address, and information from the website is displayed. The method may further comprise periodically changing the decryption key stored in the portable digital media device and in the remote server. The method may further comprise displaying a portion of the information read from the two dimensional barcode using the portable digital media device.

A method of reading a readable element, such as an RFID chip or RFID printed pattern, having encrypted information with a portable reading device, may comprise storing a decryption key in the portable reading device, scanning a readable element with the portable reading device, communicating with a remote server storing a decryption key database using the portable reading device to validate the decryption key stored in said portable reading device, and decrypting information from the readable element using the portable reading device.

Some or all of the decrypted information may be displayed. The portable reading device may be used to access a website specified by the decrypted information. The decryption key stored in the portable reading device and in the remote database may be periodically changed. The decryption key may be valid for a specified geographic location. The portable reading device may communicate the geographic location of the device along with the decryption key to the remote database for validating the decryption key stored in the portable reading device and validating the location of the portable reading device. The portable reading device may include a GPS receiver and the geographic location may be derived from the GPS receiver. The decryption key may specify a portion of the encrypted information from the readable element which is to be decrypted. The portable reading device and the remote server may communicate periodically to synchronize the decryption key. The portable reading device and the remote server may communicate wirelessly. The portable reading device and the remote server communicate over a Wi-Fi connection. The portable reading device and the remote server may communicate over the internet.

### BRIEF DESCRIPTION OF THE DRAWING

FIG. 1 is a diagrammatic representation of a portable media device scanning a two dimensional barcode, and communicating with a remote server in which a database of decryption keys is maintained; and

FIG. 2 is a diagrammatic representation of a portable reading device scanning a readable element, and communicating with a remote server in which a database of decryption keys is maintained.

### DETAILED DESCRIPTION

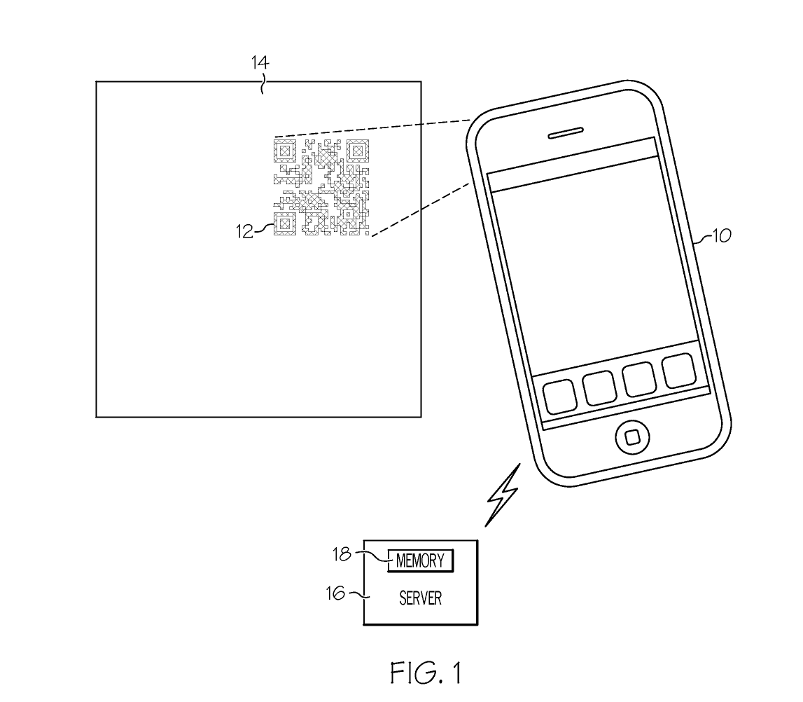

Reference is made to FIG. 1, which shows a portable media device 10, depicted as an iPhone, being used to scan a two dimensional barcode 12 printed on a document 14. The portable media device 10 may be any of a number of devices, such as for example an iPhone device from Apple Inc., a Blackberry device from RIM Inc., an Android device from Motorola, Inc., a Nexus One device from Google, Inc., or another similar device having an associated display and a memory in which is stored one or more application programs that permit the device 10 to perform a number of tasks. For some situations, the portable digital media device 10 may also be a device, such as an iTouch, which has wireless communication capability, but which does not include a built-in cell phone. Devices, such as the iTouch, may include a Wi-Fi, Mi-Fi, or other wireless broadband capability.

By “scan” is meant the act of capturing in the image of the barcode in electronic form. Typically, smart phones and the other portable digital media devices of the type described above include digital cameras which permit digital images to be captured over a wide range of focal lengths, including focal lengths of only a few inches where the image of a two dimensional bar code will fill most of the smart phone display. While this is not scanning in the sense of a laser scanner sweeping a beam of laser light over the barcode in a repetitive pattern, all forms of converting a bar code image into an electronic image are contemplated.

The two dimensional barcode 12 is shown in FIG. 1 as a QR barcode. It will be appreciated, however, that there are a variety of known two dimensional bar codes, and that other such barcodes may also be used. The QR barcode, also called a Quick Response code, is a type of matrix barcode that can be read quickly and has a relatively large storage capacity. The QR barcode includes black modules arranged in a square pattern on a white background. The information encoded may include any kind of data. The barcode 12 may include encrypted patient healthcare information, or any other information which is considered to be confidential. To maintain the confidentiality of the information in the barcode 12, it may be encrypted, if desired. The process of reading the encrypted barcode information then includes the step of decrypting the information. This requires that the iPhone 10 have a valid decryption key in order in order for the decryption process to be performed. The method of reading the two dimensional bar code 12 having encrypted information, such as encrypted patient healthcare information, therefore contemplates storing a decryption key in the memory 10 of the portable digital media device.

The two dimensional barcode 12 is scanned, i.e., the barcode image is captured, with the video camera of the portable digital media device 10. The portable digital media device 10 communicates with a remote server 16 including a memory 18 in which is stored a decryption key database to validate the decryption key. The communication between the portable digital media device 10 and the remote server 16 may be wireless, using the telephone radio capability of the smart phone, or using the Wi-Fi capability of the smart phone or other device, to access the internet, assuming that the device 10 is located in an area serviced by a wireless router. In some circumstances, the communication between the portable digital media device and the server 16 may be accomplished over hard-wired connections, such as for example a wired connection from the device 10 to an internet access port, such as may be provided by a personal computer, and then communication over the internet to the remote server 16. Once the decryption key is validated, the information from the two dimensional barcode 12 is decrypted in the portable digital media device using a decryption application. It will be appreciated that the validation process may take place before, after, or simultaneously with scanning the barcode image. For example, the communication with the server 16 may have taken place prior to the scanning of the barcode image.

After the decryption takes place, some or all of the decrypted information may be displayed on the screen of the portable digital media device 10, or on a different display to which the decrypted information is transmitted by the device 10. The decrypted information may include the address of a website. In such a case, the device 10 will access the website, where additional information may be accessed in either encrypted or unencrypted form. This information may then be displayed.

It will be appreciated that it is important that access to the encryption key be limited if the confidentiality of the information is to be maintained. In order to restrict access and to insure that the information is available only to currently authorized individuals, it may be desirable to change the decryption key frequently. This entails changing the key stored in the portable digital media device 10 and in the remote database in server 16. For this purpose, the portable digital media device 10 and the remote server 16 may communicate periodically to synchronize the decryption key stored in each. The portable digital media device 10 and the remote server 16 may communicate wirelessly, such as for example over a Wi-Fi connection. The portable digital media device 10 and the remote server 16 may communicate over the internet, which may be accessed wirelessly or over a hard-wired connection. It will be appreciated that the remote server 16 may be used to validate the decryption keys of a plurality of portable digital media devices. The server 16 maintains a database of keys in memory 18.

If desired, the decryption key may be valid only for a specified geographic location. This requires that the location of the portable digital media device 10 be sent to the remote server 16 along with the decryption key that is to be validated. The device 10 typically includes a GPS receiver which continuously updates the geographic location of the device so that this location information is always available for communication by the device 10 along with the decryption key. The decryption key may also specify that it is valid for decrypting a portion of the encrypted information from the two dimensional barcode.

It should be appreciated that this arrangement is particularly useful in handling confidential information that is to be disclosed to some individuals, but not to everyone that comes into contact with a document bearing the information. An example of this is patient medical information. Document 14 may have medical information relating to a patient printed on one or both sides in human readable form. Additionally, the document 14 carries a two dimensional barcode 12 in which is encoded additional medical information, some or all of which may be encrypted, as discussed above. Various medical professionals need access some, but perhaps not all, of the medical information on a patient's record. Encrypting the information in the two dimensional barcode 12 provides a technique for limiting access to specific portions of the medical information for certain health care providers, while allowing other health care providers to have access to different portions or to all of the medical information in the barcode. Additionally, access to the medical information may be permitted during only limited certain periods of time. Further, access to the medical information may be permitted only when the barcode is scanned at certain geographic locations, e.g., at a medical facility. All of this provides the ability to control access to different portions of the medical information, as desired.

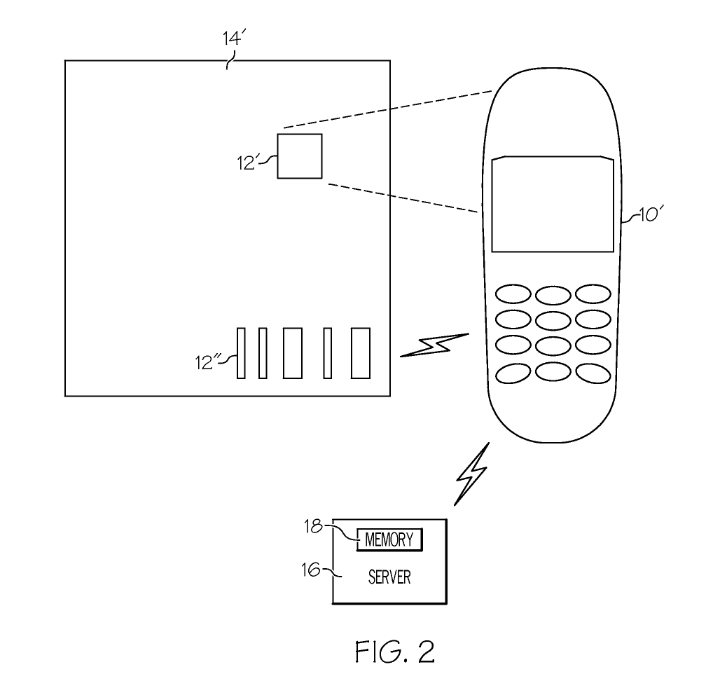

Reference is made to FIG. 2, which illustrates another embodiment of the information system in which a portable reading device 10′, depicted as an RFID reader, is being used to scan an RFID chip 12′ on a document 14′. The portable reader device 10′ may be any of a number of known portable, hand-held, battery powered RFID reader. The device 10′ includes a wireless communication capability, such as telephone radio access. Additionally, the reader device 10′ may also include a Wi-Fi, Mi-Fi, or other wireless broadband capability.

By “scan” in regard to the system of FIG. 2 is meant the act of capturing information from the RFID chip 12′. The RFID chip 12′ may be any of a number of such chips which are commonly used in RFID applications. The information encoded may include any kind of data. The chip 12′ may include encrypted patient healthcare information, or any other information which is considered to be confidential. As with the embodiment of FIG. 1, the embodiment of FIG. 2 contemplates decrypting the scanned information. This requires that the device 10′ have a valid decryption key in order in order for the decryption process to be performed. The method of reading the RFID chip 12′ therefore contemplates storing a decryption key in the memory of the portable device 10′.

The RFID chip 12′ is scanned, with the portable reading device 10′. The portable device 10′ communicates with a remote server 16 including a memory 18 in which is stored a decryption key database to validate the decryption key. This is done in the same manner as described above in regard to the embodiment of FIG. 1. The communication between the portable device 10′ and the remote server 16 may be wireless, using the telephone radio of the device, or using the Wi-Fi capability of the device, to access the internet, assuming that the device 10′ is located in an area serviced by a wireless router. As with the embodiment of FIG. 1, in some circumstances, the communication between the portable device 10′ and the server 16 may be accomplished over hard-wired connections, such as for example a wired connection from the device 10′ to an internet access port, such as may be provided by a personal computer, and then communication over the internet to the remote server 16. Once the decryption key is validated, the information from the RFID chip 12′ is decrypted in the portable digital media device using a decryption application. It will be appreciated that the validation process may take place before, after, or simultaneously with scanning the barcode image. For example, the communication with the server 16 may have taken place prior to the scanning of the barcode image.

As with the embodiment of FIG. 1, the information from the RFID chip 12′ may be handled in a number of ways. For example, the portable reading device 10′ may be used to access a website specified by the decrypted information. The decryption key stored in the portable reading device 10′ and in the remote database may be periodically changed, with the device 10′ and the remote server 16 wirelessly communicating periodically, such as by radio, by Wi-Fi or over the internet, to synchronize the decryption key. The decryption key may be valid for a specified geographic location. The portable reading device 10′ may communicate the geographic location of the device 10′, derived from a GPS receiver, along with the decryption key to the remote database for validating the decryption key and validating the location of the portable reading device 10′.

Also positioned on the document 14′ is a readable element 12″ which is a printed pattern of ink readable with a sensor that senses the effect of the pattern on a microwave signal. The ink is printed to define a pattern of dielectric material with a suspension of ferroelectric material. Such ink and the various arrangements for providing readable codes are disclosed in U.S. Pat. No. 7,221,168, issued May 22, 2007. The barcode information is encoded using different lengths, angles, or positions of dielectric bars. The reader 10′ includes a source of low level microwave energy which is transmitted to the element 12″ and a sensor that senses the effect that the barcode element 12″ has on the microwave signal. Although FIG. 2 shows an RFID chip 12′ and an RFID printed pattern 12″ on the same document 14′, it will be appreciated that only a single chip or pattern may be used on a document, and that a reader may have the ability to read only chips or patterns, as may be appropriate for the use to which it is applied.

What is claimed is:

1. A method of reading a two dimensional barcode having encrypted information with a portable digital media device, comprising:
storing a decryption key in said portable digital media device, scanning a two dimensional barcode with the video camera of a portable digital media device,
communicating with a remote server storing a decryption key database using said portable digital media device to validate said decryption key stored in said portable digital media device, and
decrypting information from the two dimensional barcode using the portable digital media device.

2. The method of reading a two dimensional barcode having encrypted information with a portable digital media device according to claim 1, further comprising displaying some or all of the decrypted information.

3. The method of reading a two dimensional barcode having encrypted information with a portable digital media device according to claim 1, further comprises using said portable digital media device to access a website specified by the decrypted information.

4. The method of reading a two dimensional barcode having encrypted information with a portable digital media device according to claim 1, further comprising periodically changing the decryption key stored in said portable digital media device and in said remote database.

5. The method of reading a two dimensional barcode having encrypted information with a portable digital media device according to claim 1, in which said decryption key is valid for a specified geographic location, and in which said portable digital media device communicates the geographic location of said device along with said decryption key to said remote database for validating said decryption key stored in said portable digital media device and validating the location of said portable digital media device.

6. The method of reading a two dimensional barcode having encrypted information with a portable digital media device according to claim 5, in which said portable digital media device includes a GPS receiver and derives the geographic location from the GPS receiver.

7. The method of reading a two dimensional barcode having encrypted information with a portable digital media device according to claim 1, in which said decryption key specifies a portion of the encrypted information from the two dimensional barcode which may be decrypted.

8. The method of reading a two dimensional barcode having encrypted information with a portable digital media device according to claim 1, in which said portable digital media device and said remote server communicate periodically to synchronize said decryption key.

9. The method of reading a two dimensional barcode having encrypted information with a portable digital media device according to claim 8, in which said portable digital media device and said remote server communicate wirelessly.

10. The method of reading a two dimensional barcode having encrypted information with a portable digital media device according to claim 9, in which said portable digital media device and said remote server communicate over a Wi-Fi connection.

11. The method of reading a two dimensional barcode having encrypted information with a portable digital media device according to claim 8, in which said portable digital media device and said remote server communicate over the internet.

12. A method of reading a two dimensional barcode having encrypted information with a portable digital media device, comprising:
storing a decryption key in said portable digital media device,
scanning a two dimensional barcode with the video camera of a portable digital media device,
communicating with a remote server storing a decryption key database using said portable digital media device to validate said decryption key stored in said portable digital media device,
decrypting information from the two dimensional barcode using the portable digital media device, said information including an internet address,
directing said portable digital media device to access a website at said internet address, and
displaying information from said website.

13. The method of reading a two dimensional barcode having encrypted information with a portable digital media device according to claim 12, further comprising periodically changing the decryption key stored in said portable digital media device and in said remote server.

14. The method of reading a two dimensional barcode having encrypted information with a portable digital media device according to claim 12, in which said decryption key is valid for a specified geographic location, and in which said portable digital media device communicates the geographic location of said device along with said decryption key to said remote database for validating said decryption key stored in said portable digital media device and validating the location of said portable digital media device.

15. The method of reading a two dimensional barcode having encrypted information with a portable digital media device according to claim 14, in which in which said portable digital media device includes a GPS receiver,

16. The method of reading a two dimensional barcode having encrypted information with a portable digital media device according to claim 12, in which said decryption key specifies a portion of the encrypted information from the two dimensional barcode which may be decrypted.

17. The method of reading a two dimensional barcode having encrypted information with a portable digital media device according to claim 12, in which said portable digital media device and said remote server communicate periodically to synchronize said decryption key.

18. The method of reading a two dimensional barcode having encrypted information with a portable digital media device according to claim 17, in which said portable digital media device and said remote server communicate wirelessly.

19. The method of reading a two dimensional barcode having encrypted information with a portable digital media device according to claim 17, in which said portable digital media device and said remote server communicate over a Wi-Fi connection.

20. The method of reading a two dimensional barcode having encrypted information with a portable digital media device according to claim 17, in which said portable digital media device and said remote server communicate over the internet.

21. The method of reading a two dimensional barcode having encrypted information with a portable digital media device according to claim 12, further comprising displaying information from the two dimensional barcode using the portable digital media device.

22. A method of reading a readable element having encrypted information with a portable reading device, comprising:
storing a decryption key in said portable reading device,
scanning a readable element with the portable reading device,
communicating with a remote server storing a decryption key database using said portable reading device to validate said decryption key stored in said portable reading device, and
decrypting information from the readable element using the portable reading device.

23. The method of reading a readable element having encrypted information with a portable reading device according to claim 22, in which the readable element is an RFID chip, and the portable reading device is a portable RFID reader.

24. The method of reading a readable element having encrypted information with a portable reading device according to claim 22, in which said readable element is a readable code created by a pattern of dielectric material with a suspension of ferroelectric material.

25. The method of reading a readable element having encrypted information with a portable reading device according to claim 22, further comprising periodically changing the decryption key stored in said portable reading device and in said remote database.

26. The method of reading a readable element having encrypted information with a portable reading device according to claim 22, in which said decryption key is valid for a specified geographic location, and in which said portable reading device communicates the geographic location of said device along with said decryption key to said remote database for validating said decryption key stored in said portable reading device and validating the location of said portable reading device.

27. The method of reading a readable element having encrypted information with a portable reading device according to claim 26, in which said portable reading device includes a GPS receiver and derives the geographic location from the GPS receiver.

28. The method of reading a readable element having encrypted information with a portable reading device according to claim 22, in which said readable element is a printed pattern of ink readable with a sensor that senses the effect of the pattern on a microwave signal.

29. The method of reading a readable element having encrypted information with a portable reading device according to claim 22, in which said portable reading device and said remote server communicate periodically to synchronize said decryption key.

30. The method of reading a readable element having encrypted information with a portable reading device according to claim 29, in which said portable reading device and said remote server communicate wirelessly.

31. The method of reading a readable element having encrypted information with a portable reading device according to claim 30, in which said portable reading device and said remote server communicate over a Wi-Fi connection.

32. The method of reading a readable element having encrypted information with a portable reading device according to claim 29, in which said portable reading device and said remote server communicate over the internet.

33. A method of reading a readable element having encrypted information with a portable reading device, comprising:
storing a decryption key in said portable reading device,
scanning a readable element with the video camera of a portable reading device,
communicating with a remote server storing a decryption key database using said portable reading device to validate said decryption key stored in said portable reading device,
decrypting information from the readable element using the portable reading device, said information including an internet address,
directing said portable reading device to access a website at said internet address, and
displaying information from said website.

34. The method of reading a readable element having encrypted information with a portable reading device according to claim 33, further comprising periodically changing the decryption key stored in said portable reading device and in said remote server.

35. The method of reading a readable element having encrypted information with a portable reading device according to claim 33, in which said decryption key is valid for a specified geographic location, and in which said portable reading device communicates the geographic location of said device along with said decryption key to said remote database for validating said decryption key stored in said portable reading device and validating the location of said portable reading device.

36. The method of reading a readable element having encrypted information with a portable reading device according to claim 33, in which said readable element is a readable code created by a pattern of dielectric material with a suspension of ferroelectric material.

37. The method of reading a readable element having encrypted information with a portable reading device according to claim 33, in which said decryption key specifies a portion of the encrypted information from the readable element which may be decrypted.

38. The method of reading a readable element having encrypted information with a portable reading device according to claim 33, in which said portable reading device and said remote server communicate periodically to synchronize said decryption key.

39. The method of reading a readable element having encrypted information with a portable reading device according to claim 33, in which said readable element is a printed pattern of ink readable with a sensor that senses the effect of the pattern on a microwave signal.

40. The method of reading a readable element having encrypted information with a portable reading device according to claim 33, further comprising displaying information from the readable element using the portable reading device.
